(19) United States
(12) Patent Application Publication
(10) Pub. No.: US 2026/0149252 A1
(43) Pub. Date: May 28, 2026

(54) BUSBAR RETAINING PROTECTOR

(71) Applicant: Yazaki Corporation, Tokyo (JP)

(72) Inventors: Hiroyuki KATO, Shizuoka (JP); Ryota KATAOKA, Shizuoka (JP)

(73) Assignee: Yazaki Corporation, Tokyo (JP)

(21) Appl. No.: 19/391,531

(22) Filed: Nov. 17, 2025

(30) Foreign Application Priority Data
Nov. 25, 2024 (JP) 2024-204713

(51) Int. Cl. H02G 5/02

(52) U.S. Cl. CPC H02G 5/025

(57) ABSTRACT

A busbar retaining protector includes a case having an accommodating portion accommodating a connection portion formed at a longitudinal end portion of a stripe-shaped flat conductor having an obliquely rising portion formed at an intermediate portion, a cover attached to the case, a lower face displacement prevention protrusion protruding from an inclined inner surface of the accommodating portion, which is inclined corresponding to the obliquely rising portion, and having a contact surface that is parallel to a lower face of the obliquely rising portion and is configured to come into contact with the obliquely rising portion to restrict displacement, and an upper face displacement prevention protrusion protruding from an inner surface of the cover and having a contact surface that is parallel to an upper face of the obliquely rising portion and is configured to come into contact with the obliquely rising portion to restrict displacement.

### CROSS-REFERENCE TO RELATED APPLICATIONS

This application is based on and claims priority under 35 USC 119 from Japanese Patent Application No. 2024-204713 filed on Nov. 25, 2024, the entire content of which is incorporated herein by reference.

### TECHNICAL FIELD

The present disclosure relates to a busbar retaining protector.

### BACKGROUND ART

In the related art, a conductive member that is connected to a power supply such as a battery and supplies electricity to an electrical component or the like has been used in a power supply circuit or the like. Such a type of conductive member may include a strip-shaped flat conductor (busbar) having a prescribed width.

The conductive member needs to ensure electrical insulation of the flat conductor. For example, there is known a technique of covering a flat conductor with an insulation material and a technique of insulating a flat conductor with a case or exterior member (protector) made of an insulation resin as disclosed in, for example, JP2012-109152A and JP2021-089890A.

For example, as illustrated in FIG. 9, a busbar retaining protector 501 includes a case 510 having a pair of accommodating portions 514 that each accommodate a connection portion 31 formed at a longitudinal end portion of a busbar 30 that is a strip-shaped flat conductor, and a cover 520 attached to the case 510 to cover a part of an upper opening of each accommodating portion 514 and retain the busbar 30.

The busbar 30 is formed with a bolt through hole 33 in the connection portion 31. The busbar 30 is further formed with an obliquely rising portion 35 bent in a plate thickness direction at an intermediate portion of the busbar 30 adjacent to the connection portion 31.

The case 510 has a substantially rectangular box shape, and the pair of accommodating portions 514 defined by a partition wall 512 are arranged side by side.

The accommodating portion 514 is provided with a busbar fixing portion 513 therein, which is integrally formed with a nut 53, and the connection portion 31 of the busbar 30 is bolted by a bolt (not illustrated) inserted through the bolt through hole 33. The accommodating portion 514 is provided with, on one side wall of a rectangular tubular peripheral wall 511 thereof, an inclined inner surface 515 inclined corresponding to the obliquely rising portion 35 of the busbar 30.

The cover 520 includes an upper wall portion 521 having a rectangular shape in a plan view, and side wall portions 523 provided at corresponding two longitudinal edge portions of the upper wall portion 521. The cover 520 is attached to the case 510 to cover upper opening sides of the pair of accommodating portions 514 with a pair of busbars 30 interposed in between. Between the cover 520 and the side wall portion 523, a locking mechanism (not illustrated) is provided, so that the cover 520 can be detachably attached to the case 510.

Therefore, the busbar retaining protector 501 can retain the pair of busbars 30 by placing the connection portions 31 of the busbars 30 on the busbar fixing portions 513 of the accommodating portions 514 and then attaching the cover 520 to the case 510 to cover the obliquely rising portions 35 of the busbars 30.

However, the busbar retaining protector 501 does not have a structure for restricting the obliquely rising portion 35 of the busbar 30, which faces the inclined inner surface 515 of the accommodating portion 514, from being inclined and displaced in a direction of an arrow A when the busbar 30 is retained. For this reason, the busbar 30 is displaced in the direction of the arrow A, and as illustrated in FIG. 10, a central axis X1 of a screw portion of the nut 53 does not coincide with a central axis X2 of the bolt through hole 33 and large displacement occurs, which may accordingly lead to deterioration of workability during bolt fastening.

The present disclosure is made in view of the above circumstance, and an object of the present disclosure is to provide a busbar retaining protector that can restrict a flat conductor from being displaced relative to an accommodating portion of a case.

### SUMMARY

The object of the present disclosure is achieved by following configurations. A busbar retaining protector includes a case having an accommodating portion configured to accommodate a connection portion formed at a longitudinal end portion of a stripe-shaped flat conductor having an obliquely rising portion formed at an intermediate portion of the stripe-shaped flat conductor, a cover configured to be attached to the case to cover a part of an upper opening of the accommodating portion and retain the flat conductor, a lower face displacement prevention protrusion protruding from an inclined inner surface of the accommodating portion, which is inclined corresponding to the obliquely rising portion, and having a contact surface that is parallel to a lower face of the obliquely rising portion and is configured to come into contact with the obliquely rising portion to restrict displacement; and an upper face displacement prevention protrusion protruding from an inner surface of the cover and having a contact surface that is parallel to an upper face of the obliquely rising portion and is configured to come into contact with the obliquely rising portion to restrict displacement.

According to the busbar retaining protector of the present disclosure, it is possible to restrict a flat conductor from being displaced relative to an accommodating portion of a case.

The present disclosure is briefly described above. Details of the present disclosure can be clarified by reading modes (hereinafter, referred to as “embodiments”) for carrying out the disclosure to be described below with reference to the attached drawings.

### BRIEF DESCRIPTION OF DRAWINGS

FIG. 1 is a perspective view of a busbar retaining protector according to an embodiment of the present disclosure;

FIG. 2 is an exploded perspective view of the busbar retaining protector illustrated in FIG. 1;

FIG. 3 is a perspective view of a cover illustrated in FIG. 2 as viewed from a rear lower side;

FIG. 4 is a perspective view of the cover illustrated in FIG. 2 as viewed from a front lower side;

FIG. 5 is a plan view of the busbar retaining protector illustrated in FIG. 1;

FIG. 6 is a cross-sectional view taken from a line VI-VI in FIG. 5;

FIG. 7 is an enlarged view of a portion VII in FIG. 6;

FIG. 8 is a schematic view using the enlarged view of the portion VII in FIG. 6, illustrating a state in which a flat conductor is restricted from being displaced;

FIG. 9 is an exploded perspective view of a busbar retaining protector in the related art; and

FIG. 10 is a sectional view illustrating a state in which a busbar is displaced in the busbar retaining protector in the related art.

### DESCRIPTION OF EMBODIMENTS

Hereinafter, an embodiment of the present disclosure will be described with reference to the drawings.

A busbar retaining protector 1 according to the present embodiment is used, for example, in an inter-stack routing module that electrically connects a plurality of battery stacks. It is needless to say that the busbar retaining protector 1 of the present disclosure can be applied not only to the inter-stack routing module according to the present embodiment but also to various power supply circuits such as a high-voltage cable that electrically connects a battery assembly and a control device such as an inverter.

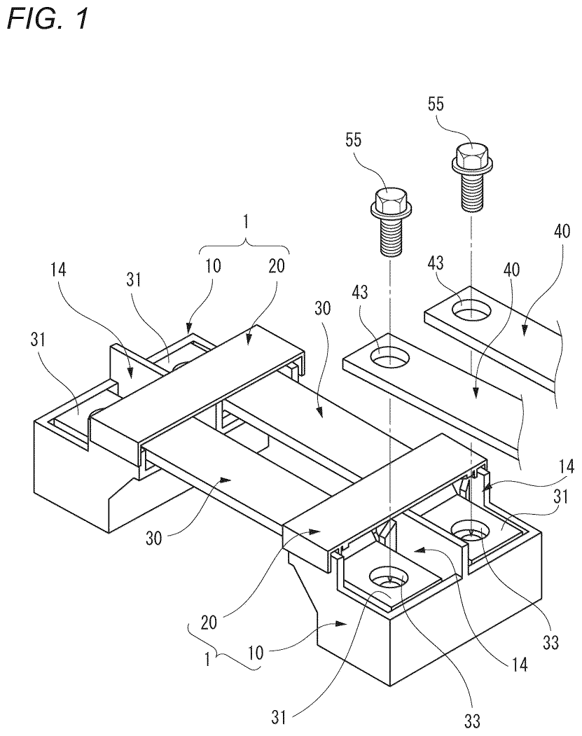

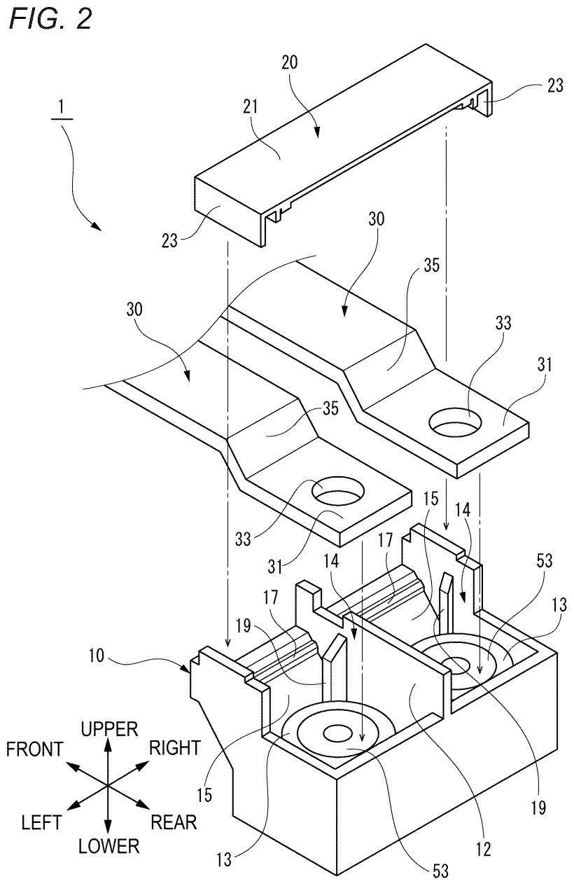

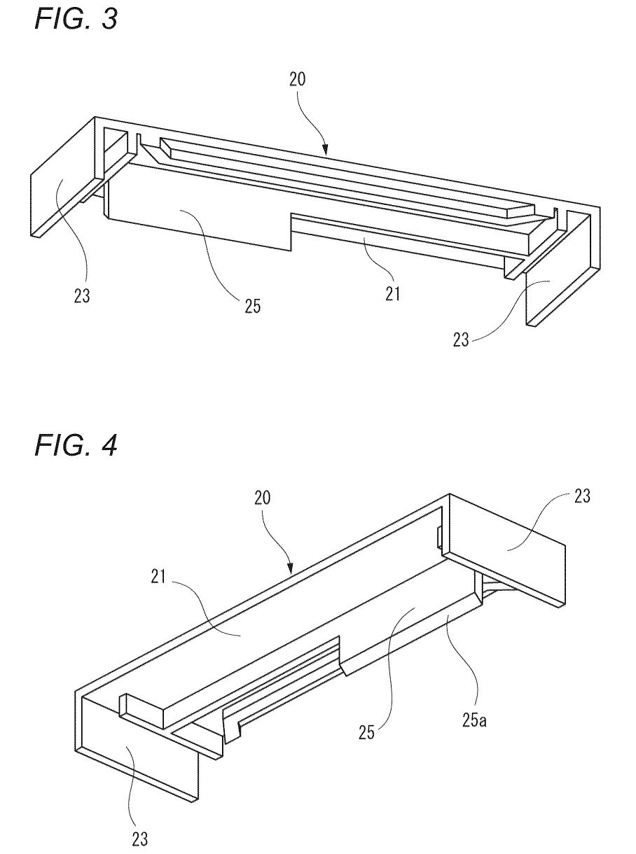

FIG. 1 is a perspective view of the busbar retaining protector 1 according to an embodiment of the present disclosure. FIG. 2 is an exploded perspective view of the busbar retaining protector 1 illustrated in FIG. 1. FIG. 3 is a perspective view of a cover 20 illustrated in FIG. 2 as viewed from a rear lower side. FIG. 4 is a perspective view of the cover 20 illustrated in FIG. 2 as viewed from a front lower side. In the present embodiment, upper-lower, front-rear, and left-right directions in the busbar retaining protector 1 follow upper-lower, front-rear, and left-right directions indicated by arrows in FIG. 2.

As illustrated in FIGS. 1 and 2, the busbar retaining protector 1 according to the present embodiment includes a case 10 having a pair of accommodating portions 14 that each accommodate a connection portion 31 formed at a longitudinal end portion of a busbar 30 that is a strip-shaped flat conductor, and a cover 20 attached to the case 10 to cover a part of an upper opening of each accommodating portion 14 and retain the busbar 30. The case 10 and the cover 20 are each integrally formed of an insulating resin by injection molding or the like.

The busbar 30 according to the present embodiment is formed of a conductive metal plate having a substantially elongated flat plate shape and pressed into a prescribed shape, and is formed with a bolt through hole 33 in the connection portion 31 formed at each of two longitudinal end portions. The busbar 30 is further formed with an obliquely rising portion 35 bent in a plate thickness direction at an intermediate portion of the busbar 30 that is adjacent to the connection portion 31.

Various conductive metal materials such as copper, a copper alloy, aluminum, and an aluminum alloy can be used for the conductive metal plate.

As illustrated in FIG. 2, the case 10 according to the present embodiment has a substantially rectangular box shape, and the pair of accommodating portions 14 defined by a partition wall 12 are arranged side by side.

The accommodating portion 14 is provided with a busbar fixing portion 13 therein, which is integrally formed with a nut 53, and the connection portion 31 of the busbar 30 is bolted by a bolt 55 inserted through the bolt through hole 33.

When the connection portion 31 of the busbar 30 is bolted to the busbar fixing portion 13, as illustrated in FIG. 1, the bolt 55 is inserted into a bolt through hole 43 of a connection terminal 40 of a battery stack and fastened together, and thereby the busbar 30 and the connection terminal 40 can be electrically connected.

The accommodating portion 14 is provided with, on one side wall (front wall) of a rectangular tubular peripheral wall 11 thereof, an inclined inner surface 15 inclined corresponding to the obliquely rising portion 35 of the busbar 30.

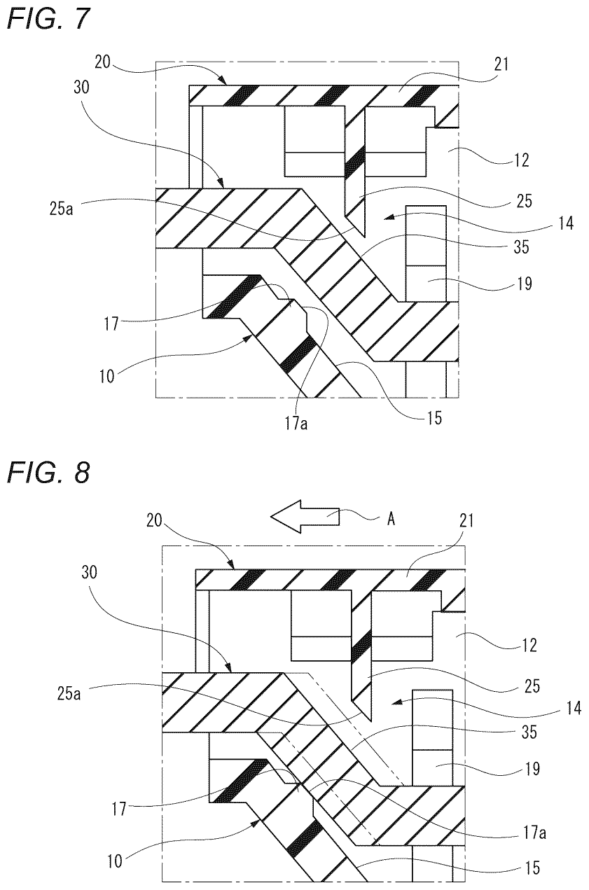

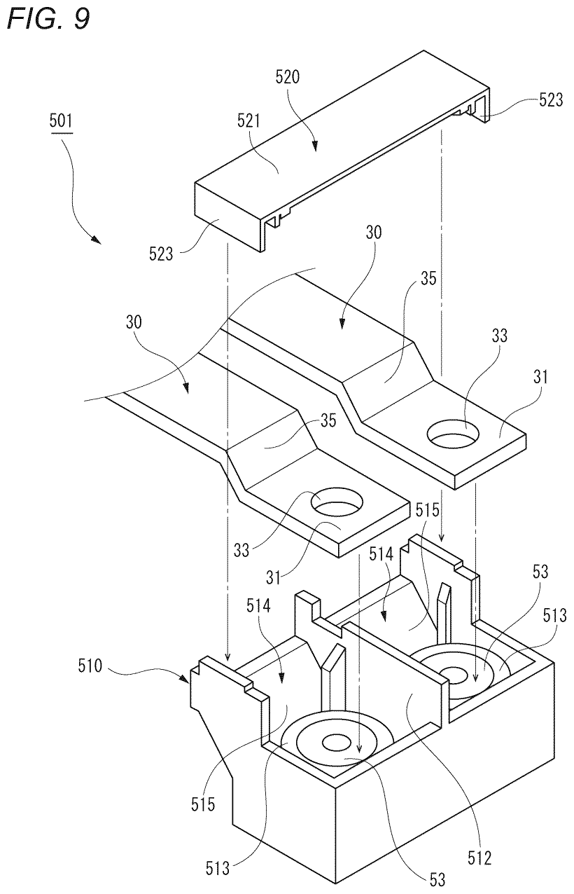

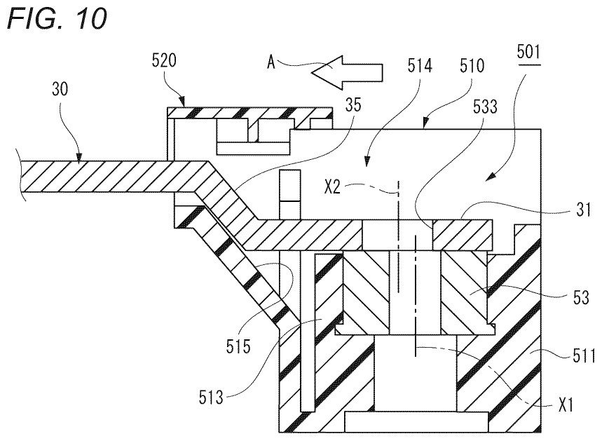

Further, the inclined inner surface 15 is provided with a lower face displacement prevention protrusion 17 that is a protruding stripe extending in the left-right direction of the case 10. The lower face displacement prevention protrusion 17 has a contact surface 17a (see FIG. 7) that is parallel to a lower face of the obliquely rising portion 35 of the busbar 30 and comes into contact with the obliquely rising portion 35 to restrict displacement of the busbar 30.

The accommodating portion 14 is further provided with positioning ribs 19 that extend in the upper-lower direction and protrude from corresponding ones of a pair of inner wall surfaces of the rectangular tubular peripheral wall 11 which face each other along the left-right direction. The positioning ribs 19 can restrict the busbar 30 from being displaced in the left-right direction.

As illustrated in FIGS. 3 and 4, the cover 20 according to the present embodiment includes an upper wall portion 21 having a rectangular shape in a plan view, and side wall portions 23 provided at corresponding two longitudinal edge portions of the upper wall portion 21. The cover 20 is attached to the case 10 to cover upper opening sides of the pair of accommodating portions 14 with a pair of busbars 30 interposed in between. Between the cover 20 and the side wall portion 23, a locking mechanism (not illustrated) is provided, so that the cover 20 can be detachably attached to the case 10.

Further, the upper wall portion 21 is provided with an upper face displacement prevention protrusion 25 that is a flat plate-shaped protruding piece extending in the left-right direction of the cover 20 and protrudes from an inner surface thereof. The upper face displacement prevention protrusion 25 has a contact surface 25a that is parallel to an upper face of the obliquely rising portion 35 of the busbar 30 and comes into contact with the obliquely rising portion 35 to restrict displacement of the busbar 30.

The upper face displacement prevention protrusion 25 according to the present embodiment protrudes only on the inner surface on a left side of the upper wall portion 21, and comes into contact with the obliquely rising portion 35 (left side in FIG. 2) of only one of the pair of busbars 30 to restrict displacement of the one busbar 30.

As illustrated in FIG. 1, two busbar retaining protectors 1 having the same configuration are disposed at corresponding two longitudinal end portions of each of the pair of busbars 30. At this time, the busbar 30 on a front side in the drawing is restricted from being displaced by the upper face displacement prevention protrusion 25 of the cover 20 of the busbar retaining protector 1 on a right side in the drawing. Further, the busbar 30 on a back side in the drawing is restricted from being displaced by the upper face displacement prevention protrusion 25 of the cover 20 of the busbar retaining protector 1 on a left side in the drawing.

That is, the pair of busbars 30 are independently restricted from being displaced by the upper face displacement prevention protrusions 25 of the covers 20 of the busbar retaining protectors 1 disposed at corresponding two longitudinal end portions of each of the pair of busbars 30. Therefore, the two longitudinal end portions of the busbar 30 are not restricted from being displaced at the same time by the upper face displacement prevention protrusion 25 of the cover 20, and thus an influence of dimensional tolerance, assembly tolerance, and the like of the cover 20 can be restricted.

The upper face displacement prevention protrusion 25 of the cover 20 may come into contact with both obliquely rising portions 35 of the pair of busbars 30 to restrict the displacement of both busbars 30, which is needless to say.

Next, effects of the above-described configurations will be described.

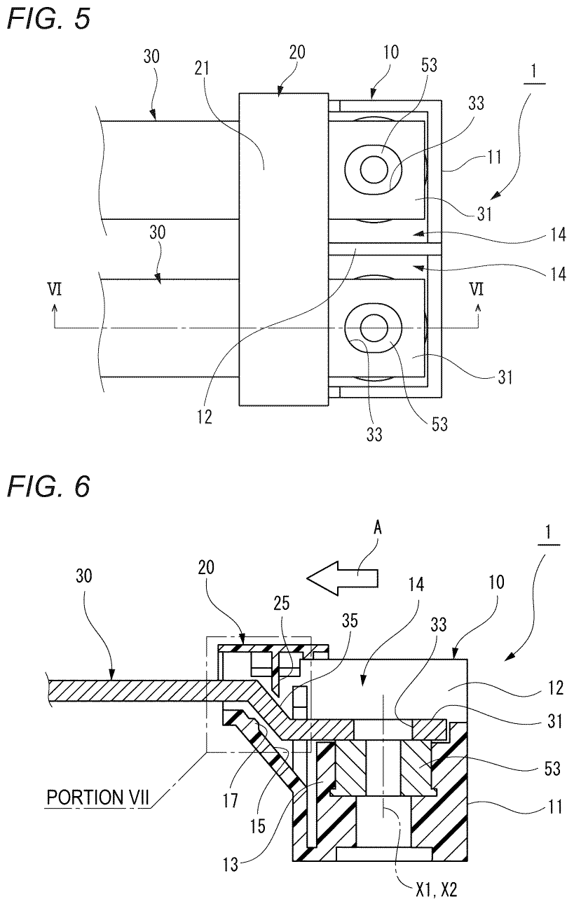

FIG. 5 is a plan view of the busbar retaining protector 1 illustrated in FIG. 1. FIG. 6 is a cross-sectional view taken from a line VI-VI in FIG. 5. FIG. 7 is an enlarged view of a portion VII in FIG. 6. FIG. 8 is a schematic view using the enlarged view of the portion VII in FIG. 6, illustrating a state in which the busbar 30 is restricted from being displaced. According to the busbar retaining protector 1 in the present embodiment, as illustrated in FIGS. 5 and 6, the pair of busbars 30 can be retained after placing the connection portions 31 of the busbars 30 on the busbar fixing portions 13 of the accommodating portions 14 and then attaching the cover 20 to the case 10 to cover the obliquely rising portions 35 of the busbars 30.

As illustrated in FIG. 7, the lower face displacement prevention protrusion 17 protrudes from the inclined inner surface 15 of the accommodating portion 14 of the case 10, and the upper face displacement prevention protrusion 25 protrudes from the inner surface of the upper wall portion 21 of the cover 20.

When the busbar 30 moves in a direction of an arrow A, as illustrated in FIG. 8, the contact surface 17a of the lower face displacement prevention protrusion 17 comes into contact with the obliquely rising portion 35, and thereby the busbar 30 can be restricted from being displaced relative to the accommodating portion 14 of the case 10. Further, when the busbar 30 moves in a direction opposite to the direction of the arrow A, the contact surface 25a of the upper face displacement prevention protrusion 25 comes into contact with the obliquely rising portion 35, and thereby the busbar 30 can be restricted from being displaced relative to the accommodating portion 14 of the case 10.

Therefore, according to the busbar retaining protector 1 in the present embodiment, the connection portion 31 of the busbar 30 retained in the accommodating portion 14 of the case 10 is restricted from being displaced, and thereby it is possible to prevent the accommodating portion 14 and the connection portion 31 from being significantly displaced and to improve workability when the connection portion 31 is fixed to the accommodating portion 14.

According to the busbar retaining protector 1 in the present embodiment, the case 10 is provided with the pair of accommodating portions 14 that accommodate the longitudinal end portions of the pair of busbars 30 arranged side by side, and the cover 20 is provided with the upper face displacement prevention protrusion 25 that comes into contact with the obliquely rising portion 35 of only one of the pair of busbars 30 to restrict displacement.

As illustrated in FIG. 1, when the two busbar retaining protectors 1 having the same configuration are disposed at corresponding two longitudinal end portions of each of the pair of busbars 30, the pair of busbars 30 are restricted from being displaced independently of each other by the upper face displacement prevention protrusions 25 of the covers 20 of the busbar retaining protectors 1 disposed at the corresponding two longitudinal end portions. Therefore, the two longitudinal end portions of the busbar 30 are not restricted from being displaced at the same time by the upper face displacement prevention protrusion 25 of the cover 20, and thus an influence of dimensional tolerance, assembly tolerance, and the like of the cover 20 on displacement can be restricted.

In the busbar retaining protector 1 according to the present embodiment, the bolt through hole 33 is formed in the connection portion 31 of the busbar 30, and the busbar fixing portion 13 including the nut 53 is provided in the accommodating portion 14 of the case 10.

Therefore, according to the busbar retaining protector 1 in the present embodiment, the connection portion 31 of the busbar 30 retained in the accommodating portion 14 of the case 10 is restricted from being displaced, and thereby it is possible to prevent a central axis X1 of a screw portion of the nut 53 and a central axis X2 of the bolt through hole 33 from being significantly displaced and to improve workability during bolt fastening.

The present disclosure is not limited to the embodiment described above, and can be appropriately modified, improved, and the like. In addition, materials, shapes, sizes, numbers, arrangement positions, and the like of components in the embodiment described above are freely selected and are not limited as long as the present disclosure can be implemented.

For example, in the busbar retaining protector 1 according to the above embodiment, the pair of accommodating portions 14 are arranged side by side in the case 10. Alternatively, the busbar retaining protector of the present disclosure is not limited thereto, and one accommodating portion 14 may be provided.

A fixing method for fixing the connection portion of the flat conductor to the accommodating portion of the case is not limited to bolt fastening, and various fixing methods such as riveting and welding may be used.

Here, features of the busbar retaining protector according to the embodiment of the present disclosure described above are briefly summarized and listed in following [1] to [3].
[1] A busbar retaining protector (1) includes:
   a case (10) having an accommodating portion (14) configured to accommodate a connection portion (31) formed at a longitudinal end portion of a stripe-shaped flat conductor (busbar 30) having an obliquely rising portion (35) formed at an intermediate portion of the stripe-shaped flat conductor (30);
   a cover (20) configured to be attached to the case (10) to cover a part of an upper opening of the accommodating portion (14) and retain the flat conductor (busbar 30);
   a lower face displacement prevention protrusion (17) protruding from an inclined inner surface (15) of the accommodating portion (14), which is inclined corresponding to the obliquely rising portion (35), and having a contact surface (17a) that is parallel to a lower face of the obliquely rising portion (35) and is configured to come into contact with the obliquely rising portion (35) to restrict displacement; and
   an upper face displacement prevention protrusion (25) protruding from an inner surface of the cover (20) and having a contact surface (25a) that is parallel to an upper face of the obliquely rising portion (35) and is configured to come into contact with the obliquely rising portion (35) to restrict displacement.

According to the busbar retaining protector (1) described in [1], the contact surface (17a) of the lower face displacement prevention protrusion (17) protruding from the inclined inner surface (15) of the accommodating portion (14) of the case (10) comes into contact with the obliquely rising portion (35) of the flat conductor (busbar 30), and the contact surface (25a) of the upper face displacement prevention protrusion (25) protruding from the inner surface of the cover (20) comes into contact with the obliquely rising portion (35) of the flat conductor (busbar 30), and thereby the flat conductor (busbar 30) can be restricted from being displaced relative to the accommodating portion (14) of the case (10).
[2] In the busbar retaining protector (1) according to [1],
   the case (10) is provided with a pair of the accommodating portions (14) that accommodate longitudinal end portions of a pair of the busbars (30) arranged side by side, and
   the cover (20) is provided with the upper face displacement prevention protrusion (25) that comes into contact with the obliquely rising portion (35) of only one of the pair of busbars (30) to restrict displacement.

According to the busbar retaining protector (1) described in [2], when two busbar retaining protectors (1) having the same configuration are disposed at corresponding two longitudinal end portions of each of the pair of flat conductors (busbars 30), the pair of flat conductors (busbars 30) are restricted from being displaced independently of each other by the upper face displacement prevention protrusions (25) of the covers (20) of the busbar retaining protectors (1) disposed at corresponding two longitudinal end portions of each of the pair of flat conductors (busbars 30). Therefore, the two longitudinal end portions of the flat conductor (busbar 30) are not restricted from being displaced at the same time by the upper face displacement prevention protrusion (25) of the cover (20), and thus an influence of dimensional tolerance, assembly tolerance, and the like of the cover (20) on displacement can be restricted.
[3] In the busbar retaining protector (1) according to [1],
   the connection portion (31) is formed with a bolt through hole (33), and
   the accommodating portion (14) is provided with a busbar fixing portion (13) including a nut (53).

According to the busbar retaining protector (1) described in [3], the connection portion (31) of the flat conductor (busbar 30) retained in the accommodating portion (14) of the case (10) is restricted from being displaced, and thereby it is possible to prevent a central axis (X1) of a screw portion of the nut (53) and a central axis X2 of the bolt through hole (33) from being significantly displaced and to improve workability during bolt fastening.

What is claimed is:

1. A busbar retaining protector comprising:
a case having an accommodating portion configured to accommodate a connection portion formed at a longitudinal end portion of a stripe-shaped flat conductor having an obliquely rising portion formed at an intermediate portion of the stripe-shaped flat conductor;
a cover configured to be attached to the case to cover a part of an upper opening of the accommodating portion and retain the flat conductor;
a lower face displacement prevention protrusion protruding from an inclined inner surface of the accommodating portion, which is inclined corresponding to the obliquely rising portion, and having a contact surface that is parallel to a lower face of the obliquely rising portion and is configured to come into contact with the obliquely rising portion to restrict displacement; and
an upper face displacement prevention protrusion protruding from an inner surface of the cover and having a contact surface that is parallel to an upper face of the obliquely rising portion and is configured to come into contact with the obliquely rising portion to restrict displacement.

2. The busbar retaining protector according to claim 1, wherein
the case is provided with a pair of the accommodating portions that accommodate longitudinal end portions of a pair of the busbars arranged side by side, and
the cover is provided with the upper face displacement prevention protrusion that comes into contact with the obliquely rising portion of only one of the pair of busbars to restrict displacement.

3. The busbar retaining protector according to claim 1, wherein
the connection portion is formed with a bolt through hole, and
the accommodating portion is provided with a busbar fixing portion including a nut.
